(19) United States
(12) Patent Application Publication
(10) Pub. No.: US 2017/0245634 A1
(43) Pub. Date: Aug. 31, 2017

(54) MULTI-PURPOSE DISPLAY UNIT

(71) Applicant: Thomas Gerald SEED, Manotick (CA)

(72) Inventors: Thomas Gerald SEED, Manotick (CA); Kevin BAILEY, Ottawa (CA); Yana KLIMAVA, Gatineau (CA)

(21) Appl. No.: 15/510,341

(22) PCT Filed: Sep. 4, 2015
(86) PCT No.: PCT/CA2015/050858

§ 371 Date: Mar. 10, 2017

Related U.S. Application Data
(60) Provisional application No. 62/049,749, filed on Sep. 12, 2014.

(51) Int. Cl. A47B 31/00; A47B 97/00; G09F 23/00; A47F 5/10; A47B 13/08; G09F 21/04; A47B 3/10; A47B 3/12

(52) U.S. Cl. CPC A47B 31/00; A47B 3/10; A47B 97/00; A47B 3/12; A47F 5/108; A47B 13/088; G09F 21/04; G09F 23/00; A47B 2031/003; A47B 2031/008; A47B 2200/008

(57) ABSTRACT

A portable kit is provided that assembles into a multi-purpose display unit. The display unit can be used to display and store documents and equipment in both outdoor and indoor working environments, such as construction sites. Both the kit and the display unit comprise a container, a tabletop, and a support frame for operatively mounting display means thereon, and related safety equipment. The display means may include a display monitor, and various other display items.

### TECHNICAL FIELD

The present invention relates to display units for use in a variety of environments, such as construction sites, both indoor and outdoor, and in services areas such as penthouses and mechanical rooms within large buildings.

### BACKGROUND

In both indoor and outdoor working environments, display units are essential as they may serve as a gathering area for workers. More particularly, once a display unit has been transported to a given site, the display unit allows workers to refer to drawings, specifications, and other important documents, in one centralized location.

In addition, the health and safety regulations and regulatory provisions in various countries require certain documents to be posted and viewable at all times. Examples of such documents include safety policies or plans, building permits, insurance certificates, worker manifests, and worker credentials. Furthermore, there is typically a requirement for accessible safety equipment in these same locations.

However, the prior art consists of display units whose size and shape make storage and transportation difficult. None of the prior art units provide a display unit that can be readily assembled and disassembled and transported. In fact, similar units require forklifts or other heavy machinery to transport to a site.

Therefore, there is a need for a display unit that can be easily transported to a given environment to store and display required documents and safety equipment. There is also a need for a display unit that is modular, i.e., the display unit can accommodate different items and display different varieties of items in a multitude of configurations.

### SUMMARY

The present invention provides a display unit that can be assembled for indoor and outdoor environments, such as at construction sites and in service areas within buildings. In accordance with one embodiment, the present invention provides a display unit as a kit to be transported to a site for assembly. In another embodiment, an assembled display unit can be transported to a site. The display unit may be a centralized location at a site for required or useful information and items to be posted, stored, modified, and made available to any user with access to the display unit.

In a first aspect, the present disclosure provides a kit for storing a display unit comprising: a container having a first opening; a tabletop for operatively attaching to the container at the first opening for use as a table; and a support frame for operatively mounting displays means thereon; wherein the support frame is constructed and arranged to operatively couple to the container such that the support frame can support the display means mounted thereon; and wherein the tabletop and the support frame are constructed and arranged for storage.

In a second aspect, the present disclosure provides a display unit comprising: a container having a first opening; a tabletop for operatively attaching to the container at the first opening for use as a table; and a support frame for operatively mounting display means thereon; wherein the support frame is constructed and arranged to operatively couple to the container such that the support frame can support the display means mounted thereon; and wherein the tabletop and the support frame are constructed and arranged for storage.

### BRIEF DESCRIPTION OF THE DRAWINGS

The embodiments of the present invention will now be described by reference to the following figures, in which identical reference numerals in different figures indicate identical elements and in which:

FIG. 1 is an isometric view of the kit according to one embodiment of the present invention;

FIG. 2 is a top view of the kit showing the interior of the container according to yet another embodiment of the present invention;

FIG. 3 is a top view of the kit showing the interior of the container where various elements of the kit are organized and securely fitted within the container according to another embodiment of the present invention;

FIG. 4 is an isometric view of the assembled display unit according to another embodiment of the present invention;

FIG. 5A shows various elements of the display unit according to one embodiment of the present invention; FIG. 5B shows various other elements of the display unit, such as the display means, according to one embodiment of the present invention;

FIG. 6 is a front view of the display unit according to another embodiment of the present invention;

FIG. 7 is a back view of the display unit according to a further embodiment of the present invention;

FIG. 8 is a side view of the assembled display unit according to another embodiment of the present invention;

FIG. 9 is a front isometric view of the partially assembled display unit according to another embodiment of the present invention;

FIG. 10A is a top isometric view of the tabletop; FIG. 10B is a bottom isometric view of the tabletop; FIG. 10C is a bottom view of the tabletop;

FIG. 11A is an isometric view of the kit according to another embodiment of the present invention; FIG. 11B is an isometric view of the display unit according to another embodiment of the present invention;

FIG. 12 is an isometric view of the kit according to another embodiment of the present invention;

FIG. 13 is an isometric view of the display unit according to another embodiment of the present invention;

FIG. 14 is an isometric view of the kit according to another embodiment of the present invention;

FIG. 15 is an isometric view of the display unit according to another embodiment of the present invention;

FIG. 16 is an isometric view of the display unit according to yet another embodiment of the present invention;

FIG. 17 is an isometric view of the display unit according to a further embodiment of the present invention;

FIG. 18 is an isometric view of the display unit according to another embodiment of the present invention;

FIG. 19 is an isometric view of the display unit according to one embodiment of the present invention;

FIG. 20 is an isometric view of the display unit according to another embodiment of the present invention;

FIG. 21 is a side view of the display unit according to a further embodiment of the present invention;

FIG. 22 is a side view of the display unit according to yet another embodiment of the present invention;

FIG. 23 is a front isometric view of the display unit according to an embodiment of the present invention;

FIG. 24 is a rear isometric view of the display unit according to another embodiment of the present invention;

FIG. 25 is a rear isometric view of an isolated portion of the display unit according to a further embodiment of the present invention;

FIG. 26 is a front isometric view of an isolated portion of the display unit according to one embodiment of the present invention;

FIG. 27 is a front isometric view of an isolated portion of the display unit according to another embodiment of the present invention; and

FIG. 28 is a front isometric view of an isolated portion of the display unit according to a further embodiment of the present invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicate that two or more elements are in either direct or indirect (with other intervening elements between them) physical or electrical contact with each other, or that the two or more elements co-operate or interact with each other (e.g. as in a cause and effect relationship).

The present invention advantageously provides a compact, portable, and easily transportable kit that assembles into a multi-purpose display unit.

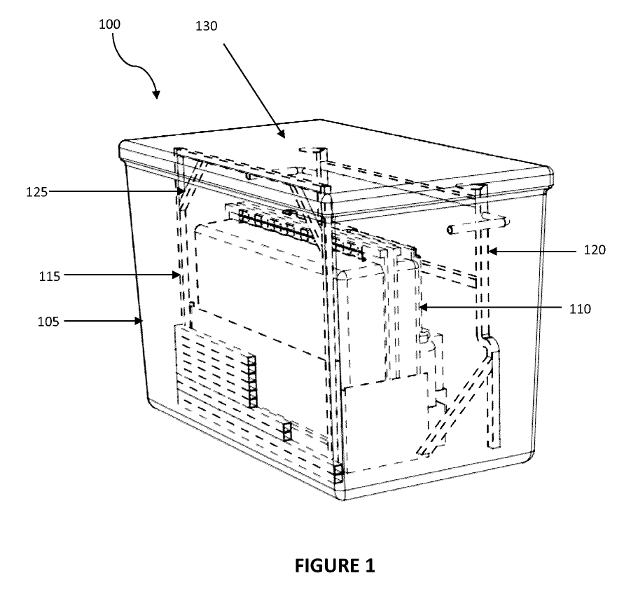

FIGS. 1 through 28 show schematic representations of various embodiments of the present invention and will now be described in greater detail.

FIG. 1 shows a kit 100 according to one embodiment of the present invention. As shown in FIG. 1, the kit 100 for storing a display unit is comprised of a container 105, a tabletop 110, and a support frame 120. The container has a first opening 130. The tabletop 110 operatively attaches to the container 105 at the first opening 130 for use as a table. The support frame 120 is constructed and arranged for operatively mounting a displays means 115 thereon. The support frame 120 is also constructed and arranged for operatively coupling to the container 105 such that the support frame 120 can support the display means 115 mounted thereon. The container 105 may be partially or fully hollow, or compartmentalized, to allow for storage of the tabletop 110, the support frame 120, and the display means 115.

For clarity, elements of the kit may be stored and removed through the first opening 130. However, as described later, other openings are envisaged. It is also noted that the support frame 120 is preferably collapsible for easier storage inside the container 105.

FIG. 1 also shows a mounting frame 125 in the kit 100. In accordance with a further embodiment of the present invention, the display means 115 may include the mounting frame 125 to further support displayed items. The mounting frame 125 may be collapsible into the container and is constructed and arranged to couple to the support frame.

To clarify, the support frame 120 and the mounting frame 125 may be two separate frames. Either or both frames may be collapsible. As well, both frames may be a unitary frame that may also be disassembled and stored in the container 105.

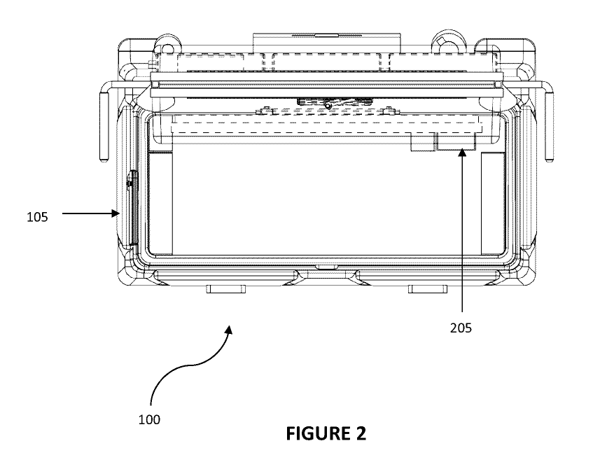

FIG. 2 shows a top view of the kit 100 showing the interior of the container 105 according to another embodiment of the present invention. Organizational brackets 205 can be stored in the container for easy organization and storage of other elements of the kit 100.

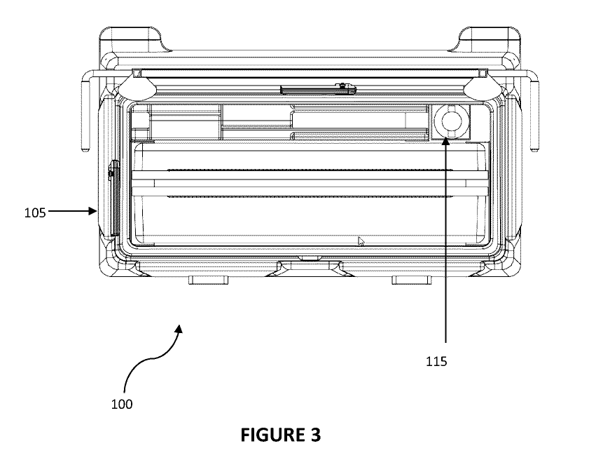

FIG. 3 shows a top view of the kit 100 showing the inside of the container 105 with various elements of the kit 100 being stored inside.

An important feature of the current invention is the ability to store all of the elements of the kit 100 inside the container 105. This allows for ease of transportation and storage of the kit 100.

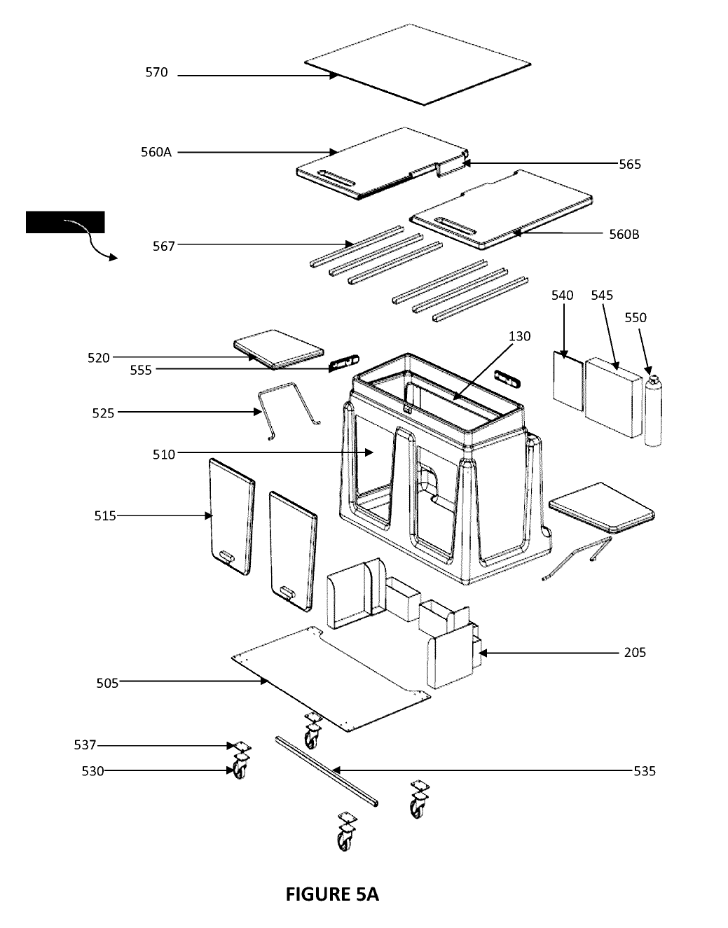

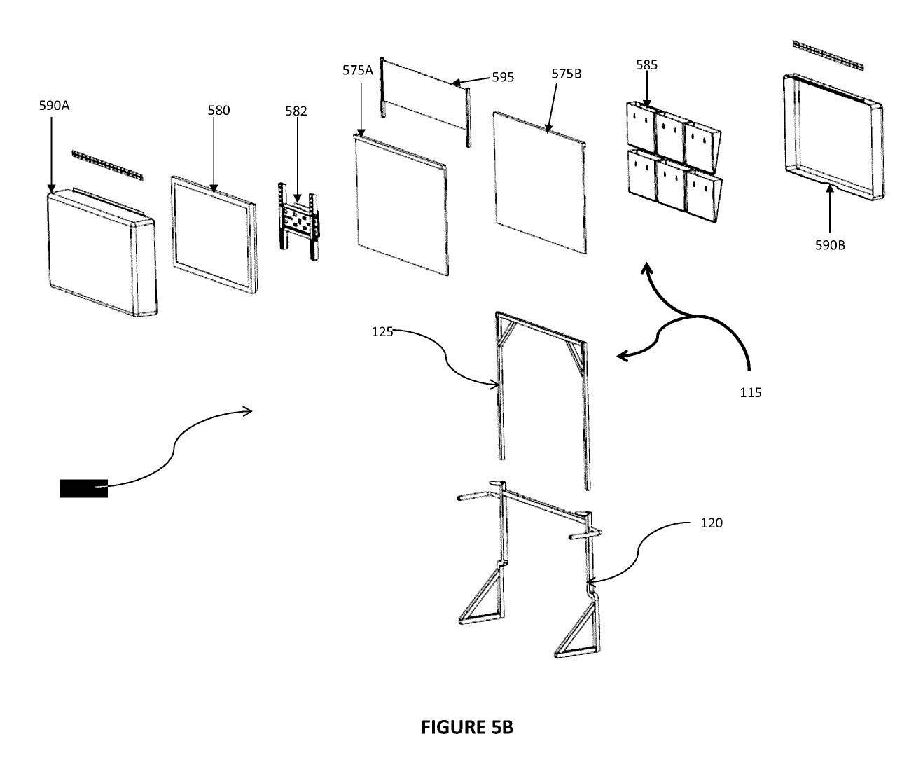

In another embodiment of the present invention, the kit comprises a support plate 505 (shown in FIG. 5A) attached to the bottom of the container 105 or stored therein for attachment to the container when the display unit is assembled.

In another embodiment of the present invention, a plurality of wheels (shown in FIG. 5A) is stored in the container 105 and operatively coupled to the container 105 when assembled for more readily moving the container 105.

In a further embodiment of the present invention, the kit 100 includes at least one tabletop support beam (shown in FIG. 5A) for operatively coupling to the tabletop 110 for structural support.

In another embodiment of the present invention, the display means may include any one of the following: a protective cover, a display monitor, a display monitor mount, at least one mounting board, a signage banner, at least one file organizer, an eyewash station, a first aid kit, a fire extinguisher, at least one power outlet, at least one organizational bracket, a defibrillator and a combination thereof (shown in FIGS. 5A, 5B). We should note that these items may be stored in the container or mounted to the display unit.

In another embodiment of the present invention, the kit 100 is sized to fit through a standard or non-standard doorway or entryway. Dimensions are fully customizable depending on the site requirements.

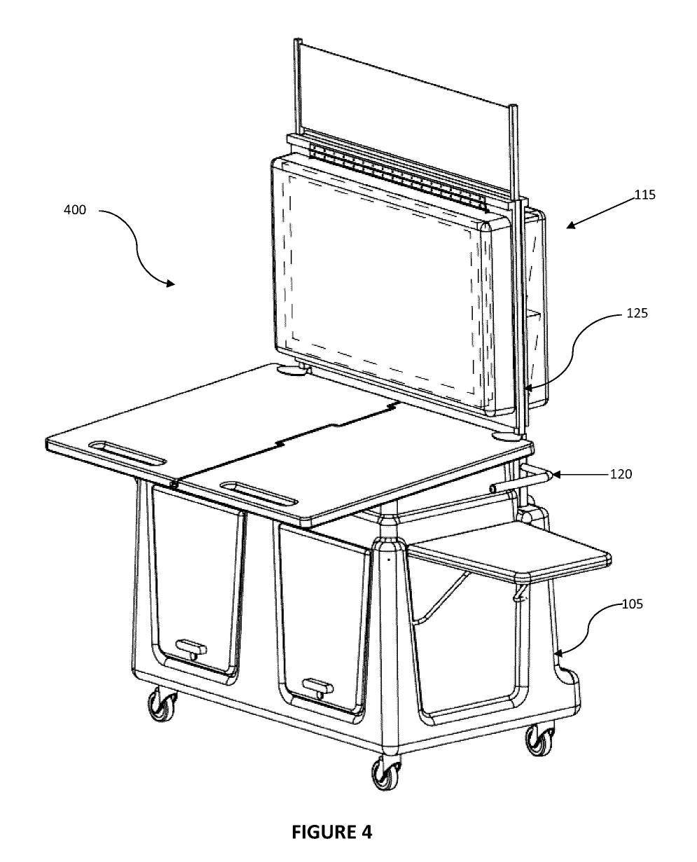

FIG. 4 shows a front isometric view of the display unit 400 assembled according to another embodiment of the present invention. The display unit 400 is comprised of the container 105, the tabletop 110, and the support frame 120. The container includes the first opening 130. The tabletop 110 is attached to the container 105 at the first opening 130 for use as a table. The support frame 120 is mounted to the display means 115 thereon and is operatively coupled to the container 105 such that the support frame 120 can support the display means 115 mounted thereon.

It should be noted that the container 105 of the display unit 400 may be constructed from a durable, lightweight material, suitable for indoor and outdoor construction sites, such as a fiberglass, strong polymer plastics, and metal. The display unit 400 may also be made from rust resistant materials and wood or other organic materials. The use of more rugged materials ensures that the kit 100 and the display unit 400 can withstand rough conditions, typically found on construction sites and service areas. The choice of materials also ensures that the kit 100 and the display unit 400 can withstand frequent transportation without suffering material deterioration. Furthermore, it should be understood that the container 105 may be made of suitable material for weight bearing items that are heavy or large.

In another embodiment of the present invention, the display unit 400 is sized to fit through a standard or non-standard doorway or entryway. Dimensions are fully customizable depending on the site requirements.

FIG. 5A and FIG. 5B, in combination, show various individual elements of the assembled display unit 400 according to one embodiment of the present invention.

FIG. 5A shows various assembled elements of the display unit 400 according to one embodiment of the present invention, which includes the container 105, the tabletop 110, and a support plate 505 attached to the bottom of the container 105.

In another embodiment of the present invention, a plurality of wheels 530 may be operatively coupled to the container 105 for moving the container 105. Each wheel 530 may be coupled to a reinforcement plate 537 that may be connected to the bottom of the container 105 itself or to the support plate 505. A support plate reinforcement means 535 may be fastened under the support plate 505 providing for further support to the support plate 505 and the container 105.

In a further embodiment of the present invention, the display unit 400 includes tabletop support beams 567 for operatively coupling to the tabletop 110 for structural support.

The container 110 may also include organizational brackets 205. Moreover, the container 105 may include side openings 510 on the sides on the container 105. In one embodiment of the present invention, the side openings 510 are located at the front of the container 105. A door 515 may be attached to the container at the side opening 510 to enable access to the container 105 through the side opening 510. A shelf 520, supported by a shelf support 525, may also be operatively coupled to the container. The shelf 520 provides for additional table surface area.

The display means 115 of the display unit 400 may include various pieces of equipment, depending on a user's requirements. Such equipment may be attached to the display unit for easy access. For instance, when the display unit is used on construction sites, an eyewash station 540, a first aid kit 545, a defibrillator, and a fire extinguisher 550 may be attached to the container 105. Electrical power outlets 555 may also be attached to the inside and/or outside of the container 105. In one embodiment of the present invention, the display unit may include a power supply such as a battery or a generator. In another embodiment, the display unit may be connected to an external power supply.

In one embodiment of the present invention, the tabletop 110 may be formed of panels 560. Each panel, panel 560A and 560B, may include a locking means 565 to securely fasten panels 560A and 560B to each other. The locking means 565 of panels 560 may include a male and female locking mechanism. The surface area created by the locked panels 560 may correspond to the surface area of the first opening 130.

In another embodiment of the present invention, the surface area created by the locked panels 560 may exceed the surface area of the first opening 130 providing for further working area. Moreover, each panel 560 may rest on support beams 567 for better structural support of the panels 560.

In yet another embodiment of the present invention, an e-size paper sheet 570 may be placed on top of the tabletop 110. The present invention contemplates a variety of paper sheet sizes and configurations.

In a further embodiment of the present invention, each wheel 530 may be a lockable wheel, allowing users to prevent the display unit 400 from rolling.

In another embodiment of the present invention, the door 515 may possess a locking mechanism, allowing users to lock the door 515 if necessary.

In yet another embodiment of the present invention, the container 105 may be made of reinforced plastic, or any material of similar or greater strength known to the skilled artisan. The support plate 505 may also be made of metal, such as steel, stainless steel, or lightweight aluminum, or any material of similar or of greater strength known to the skilled artisan.

In a further embodiment of the present invention, a ring (not pictured), hook, or the like, may be attached to the container 105 or the support plate 505, allowing the display unit 400 to be secured in place with a rope, a chain, or any other type of cord known to the skilled artisan.

In another embodiment of the present invention, a GPS tracking device may be inserted within the unit. In some embodiments, this GPS device may be utilized to protect the display unit from theft.

FIG. 5B shows various elements the display unit 400, such as the display means 115. The display means 115 may include a mounting frame and may be attached to the display unit 400, allowing users to view or access equipment, tools, display monitors, display boards, file organizers, and other such items.

A mounting board 575, or multiple mounting boards 575A and 575B, may be mounted on either side of the mounting frame 125. Such boards may provide a greater surface area on which to display documents, equipment, and tools.

In one embodiment of the present invention, a display monitor 580 may be mounted onto the mounting board 575 using a display monitor mount 582. The display monitor may be include two-dimensional displays, such as but not limited to, cathode ray tube display (CRT), light-emitting diode display (LED), electroluminescent display (ELD), electronic paper, E-Ink, plasma display panel (PDP), liquid crystal display (LCD), high-Performance addressing display (HPA), thin-film transistor display (TFT), organic light-emitting diode display (OLED), surface-conduction electron-emitter display (SED), laser television, carbon nanotubes, quantum dot display, and interferometric modulator display (IMOD). Three-dimensional displays are also contemplated, such as but not limited to, swept-volume display, varifocal mirror display, emissive volume display, laser display, holographic display, and light field displays. In one embodiment of the present invention, the display monitor 580 may be of a sizeable dimension to allow a user to view entire documents or other media on a large screen without requiring the removal of gloves or other personal protective equipment. Touch-screen displays are also contemplated to enable users to enlarge or shrink (i.e., zoom in and out) documents being displayed so as to provide multiple viewing resolutions and sizes.

File organizers 585 may be attached to the mounting board 575 allowing for storage of documents. The equipment or tools being mounted onto the mounting board 575 may also be protected by a protective cover 590, which may be comprised of two attachable sides 590A and 590B, for sheltering the display means 115 from weather damage when the display unit 400 is used outside. A signage banner 595 may also be attached to the mounting frame 575.

In another embodiment of the present invention, the mounting board 575 may be a corkboard, a pegboard, a slatwall, a plywood board, or any other type of board known to the skilled artisan.

In yet another embodiment of the present invention, corkboards, pegboards, slatwalls, plywood boards, and any other type of board known to the skilled artisan, may be mounted on the mounting board 575.

In a further embodiment of the present invention, cup holders and radio devices, such as walkie-talkies may be mounted on or attached to the display unit 400.

In another embodiment, a weather-proof or resistant canvas cover for use during transportation of the display unit is also contemplated.

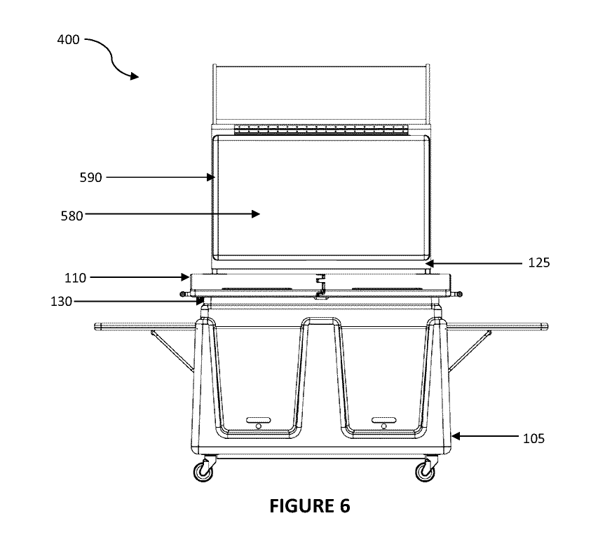

FIG. 6 shows a front view of the assembled display unit 400 according to one embodiment of the present invention.

As shown in FIG. 6, the display means may be arranged behind the container 105. The tabletop 110 as shown in FIG. 6 has a size substantially equal to or greater than the size of the first opening 130 of the container 105. This ensures that the first opening 130 is substantially covered, concealing and protecting documents or equipment inside the container 105. However, it should be readily understood by the skilled artisan that the tabletop 110 may partially cover the first opening 130.

The tabletop 110, as shown in FIG. 6, may also be inclined relative to the first opening of the container 105. The incline may be helpful to a user for ergonomic, comfort, convenience or viewing purposes.

As further shown in FIG. 6, the mounting frame 125 may be placed at the rear of the container 105. A display monitor 580 may also be attached to the mounting frame 125 using a display monitor mount. The mounting frame 125 may also be used to post documents such that documents are visible and accessible to users of the display unit 400. In addition, the display monitor 580 may be covered by the protective cover 590. The protective cover 590 may be transparent allowing outside viewers to see through the protective cover 590. Also, the protective cover 590 may be made of vacuum formed acrylic, or similar transparent and/or weather-proof material.

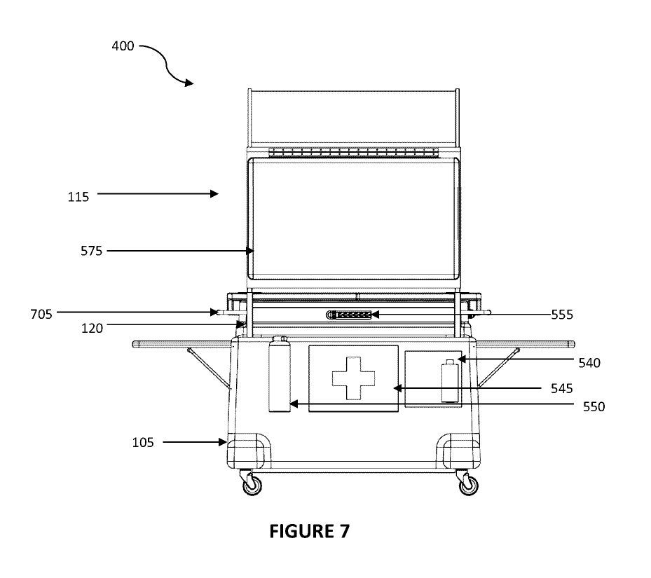

FIG. 7 shows a back view of the display unit 400. As shown in this embodiment of the present invention, the display means 115 may include an eyewash station 540, a first aid kit 545, a fire extinguisher 550, a defibrillator, and a power bar 555, or an electrical outlet. These elements of the display means 115 may be located at the rear of the display unit 400. This allows a user of the display unit 400 to readily and easily access these pieces of equipment. Depending on the particular use of the display unit 400, other types of equipment may be attached onto the rear of the display unit 400.

In addition to power bars 555 or electrical outlets, a variety of other outlets may be attached to the display unit 400 or the container 105 in particular, such as Universal Serial Bus (USB) ports, High Definition Multimedia Interface (HDMI) ports, Video Graphics Array (VGA) ports, or other digital, data, or electrical outlets that may be required.

Additionally, at least one handle 705 may be provided on either side of the support frame 120. The handles 705 allow a user to comfortably grip the display unit 400 when assembled or partially assembled.

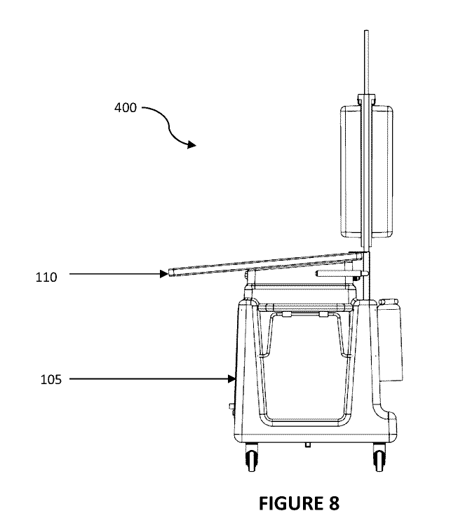

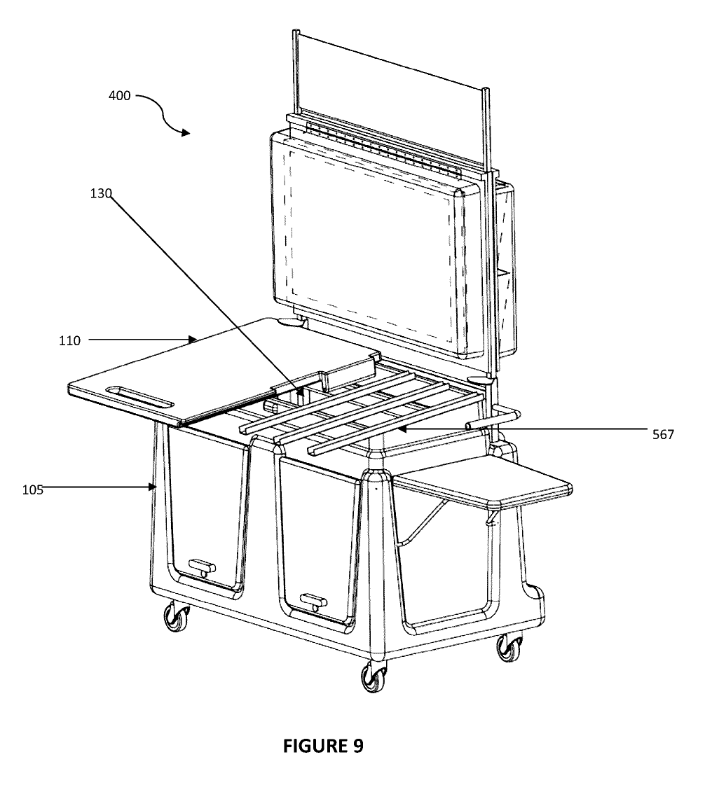

FIG. 8 shows a side view of the display unit 400 according to another embodiment of the present invention. Here the tabletop 110 extends beyond the area provided by the first opening of the container 105. This provides a greater surface area where users of the display unit 400 will have a sufficient amount of space to, for instance, draft or lay out architectural plans or any other type of document that requires a large surface area.

FIG. 9 shows a front isometric view of the display unit 400 being partially assembled. In FIG. 9, the tabletop 110 and the support beams 567 extend beyond the first opening 130 of the container 105.

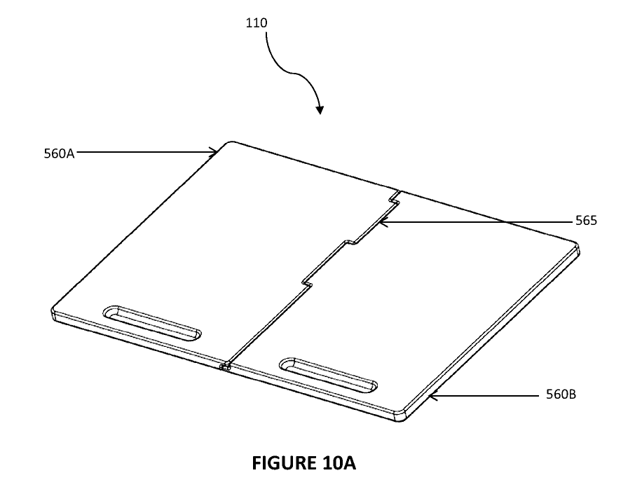

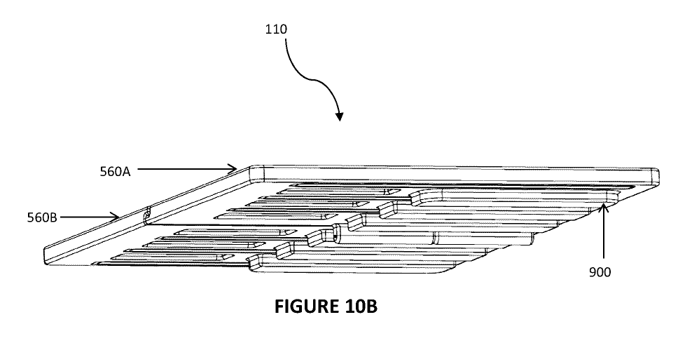

FIG. 10A shows a top isometric view of the tabletop 110. FIG. 10B shows another isometric view of the tabletop 110. FIG. 10C shows a bottom view of the tabletop 110.

As discussed above, an embodiment of the present invention includes a tabletop 110 that may comprise two panels 560A and 560B. Each panel 560A and 560B includes a panel locking means 565. As shown in FIG. 10A, the panel locking means 565 may be a male and female locking mechanism. It should be readily understood to the skilled artisan that the tabletop 110 may be unitary or may be made of at least two panels.

Also, as shown in FIG. 10B, tabletop securing means 900 are used to secure the tabletop 110 onto the first opening 130. The securing means may be a variety of locking mechanisms as envisaged by the skilled artisan.

It should also be noted that the tabletop 110 may include grooves on its top surface. These grooves may temporarily store tools frequently used on drafting tables, such as pencils, markers, scales, etc.

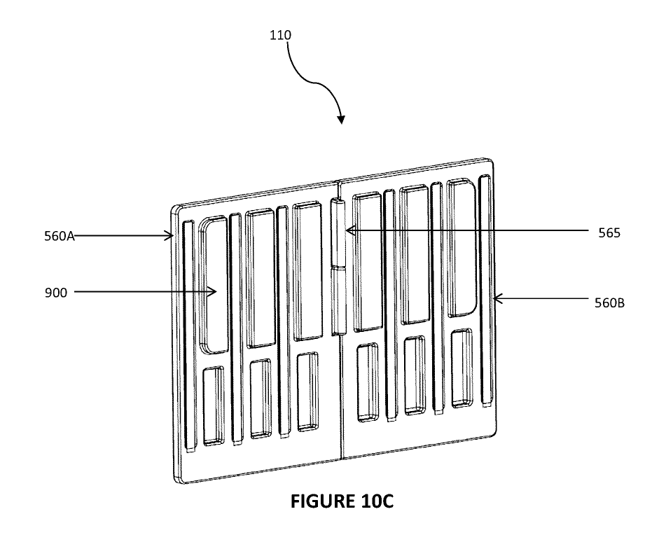

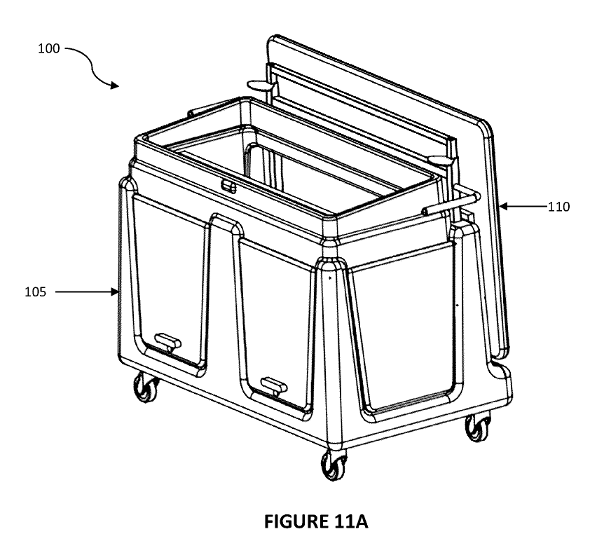

FIG. 11A shows the kit 100 according to another embodiment of the present invention. As shown in FIG. 11A, the tabletop 110 may be a unitary piece, solid or hollow, that can be stored outside the container by securing the tabletop 110 to a side of the container 105.

FIG. 11B shows the display unit 400 according to another embodiment of the present invention. As shown in FIG. 11B, the tabletop 110 may be a unitary piece.

FIG. 12 shows the kit 100 according to another embodiment of the present invention. As shown in FIG. 12, the container 105 may be an open frame container.

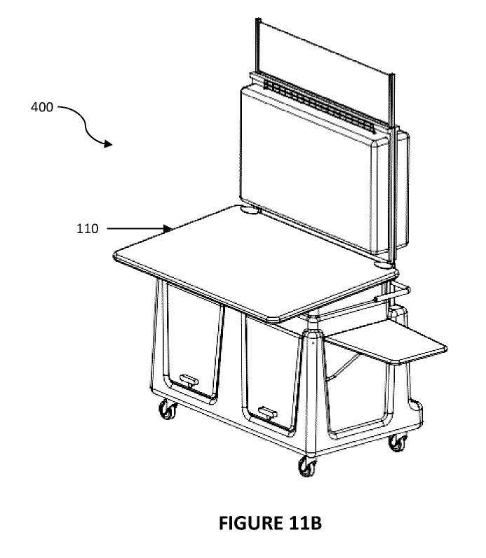

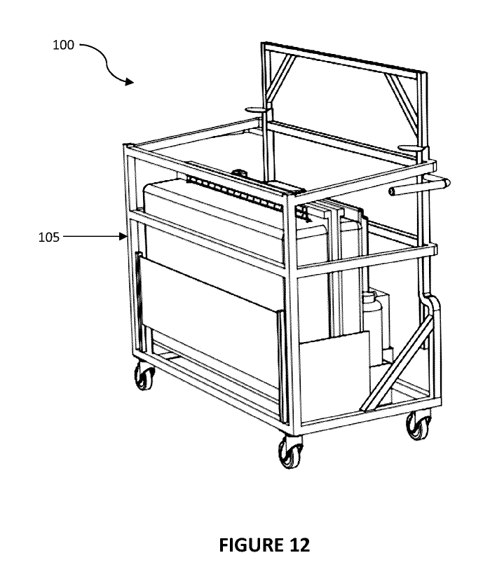

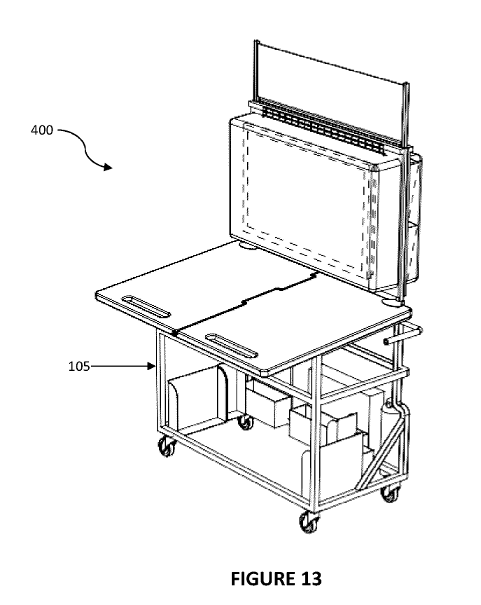

FIG. 13 shows the display unit 400 according to another embodiment of the present invention. As shown in FIG. 13, the container 105 may be an open frame container.

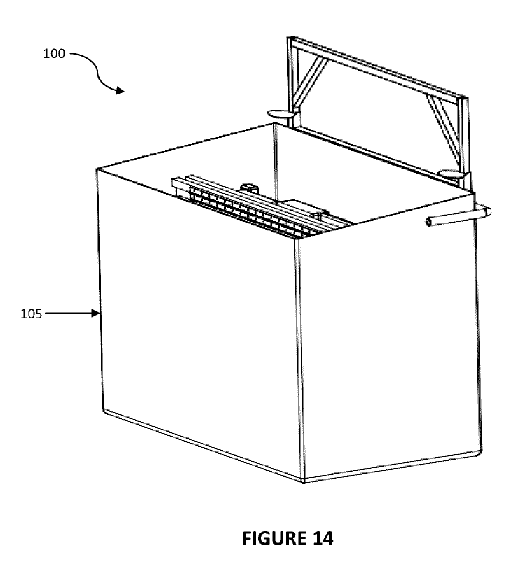

FIG. 14 shows the kit 100 according to another embodiment of the present invention. In FIG. 14, the container 105 does not include elements such as doors, side openings, shelves, and shelf supports. Rather, the container 105 has a substantially smooth surface.

FIG. 15 shows the display unit 400 according to another embodiment of the present invention. In FIG. 15, the container 105 does not include elements such as doors, side openings, shelves, and shelf supports.

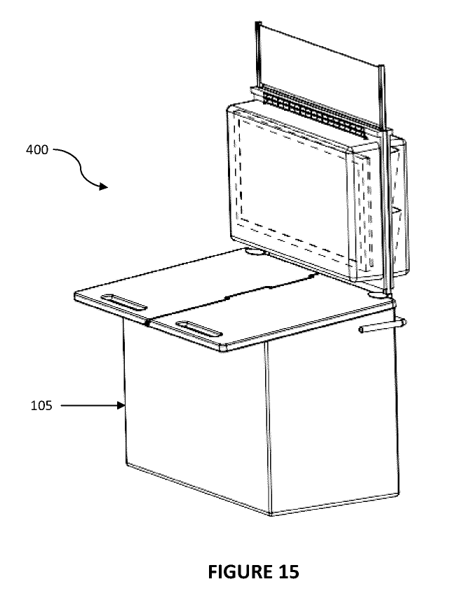

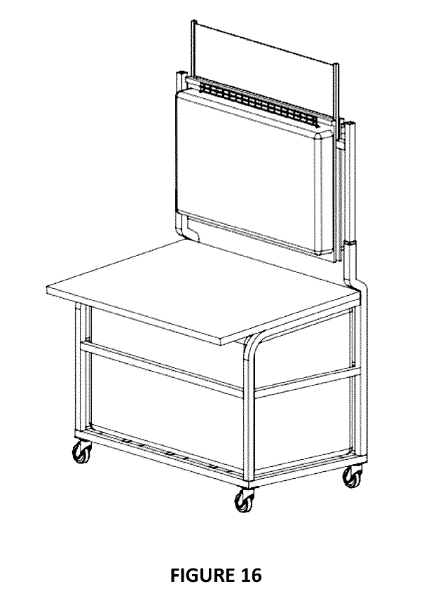

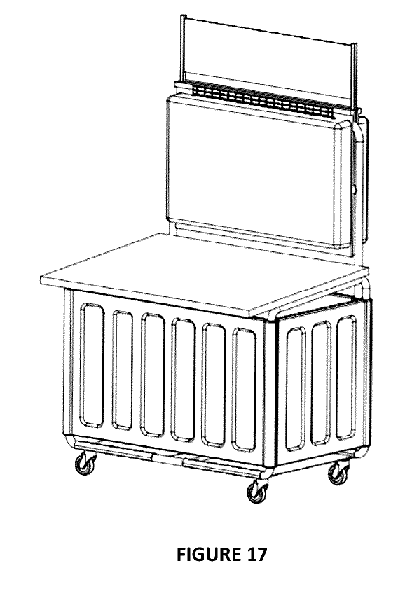

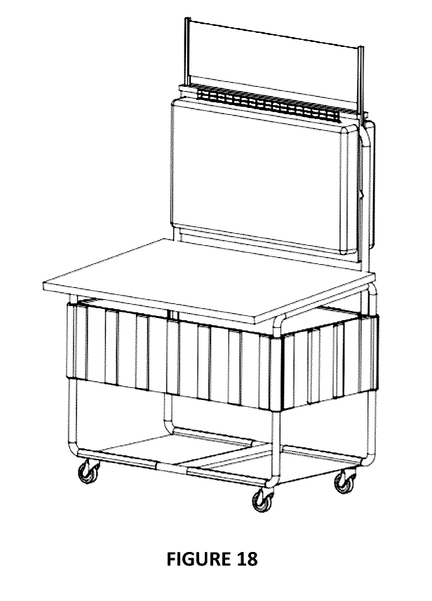

For further clarity, the container may be any structure that is capable of retaining various elements within. In other words, the sides of the container may be open or partially open or may form a complete side surface as would be readily understood by the skilled artisan. As shown in FIG. 16, the container may include an outside frame. As shown in FIG. 17, the container may comprise an open frame with side panels and bottom panels attached thereon. As shown in FIG. 18, the container may comprise an open frame with side panels attached thereon, such that the sides of the container are partially open.

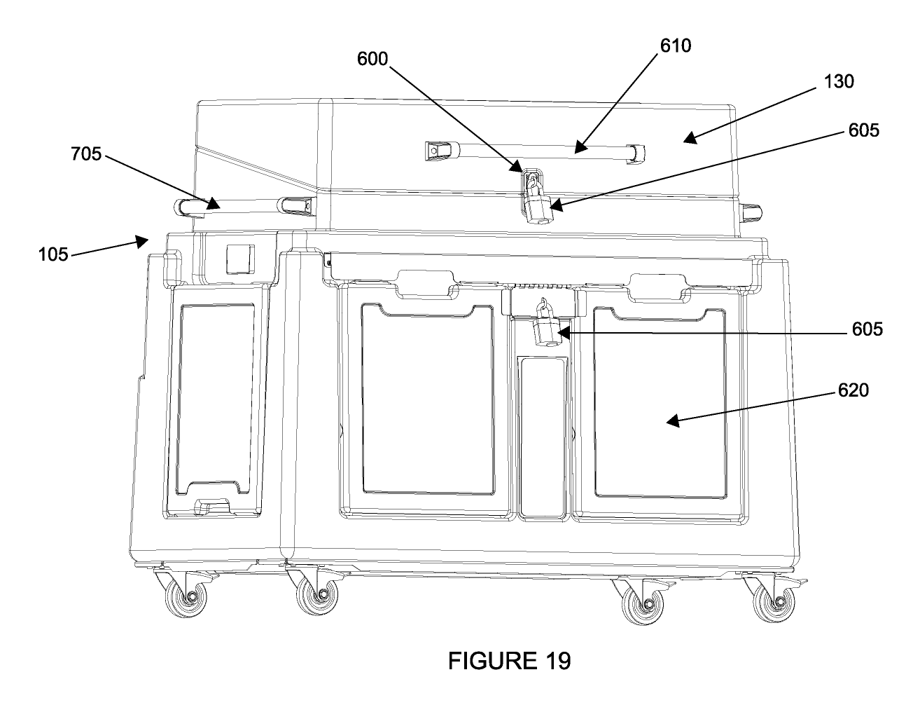

FIG. 19 shows a further embodiment of the present invention where the container 105 is structurally integrated with the elements of the kit 100. In one embodiment, the first opening 130 of the container 105 may include a securing means 600 secured with a lock 605, and may further comprise at least one top handle 610 to lift the opening. In one embodiment, the container 105 may include compartment doors 620, which are shown in a closed configuration in FIG. 1. In this embodiment, the compartment doors 620 are secured by a lock 605.

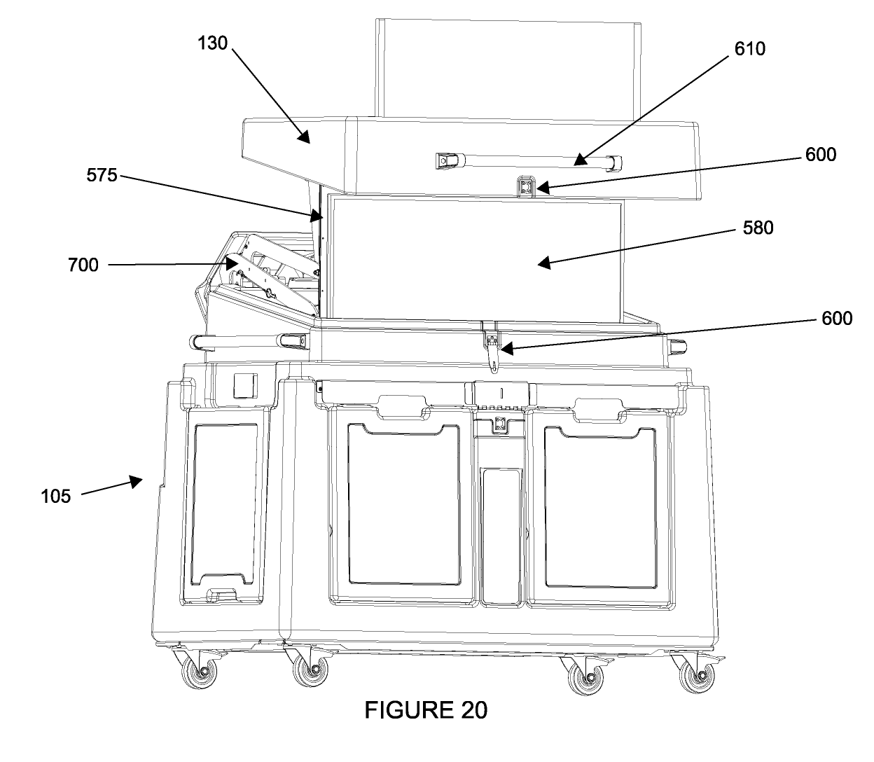

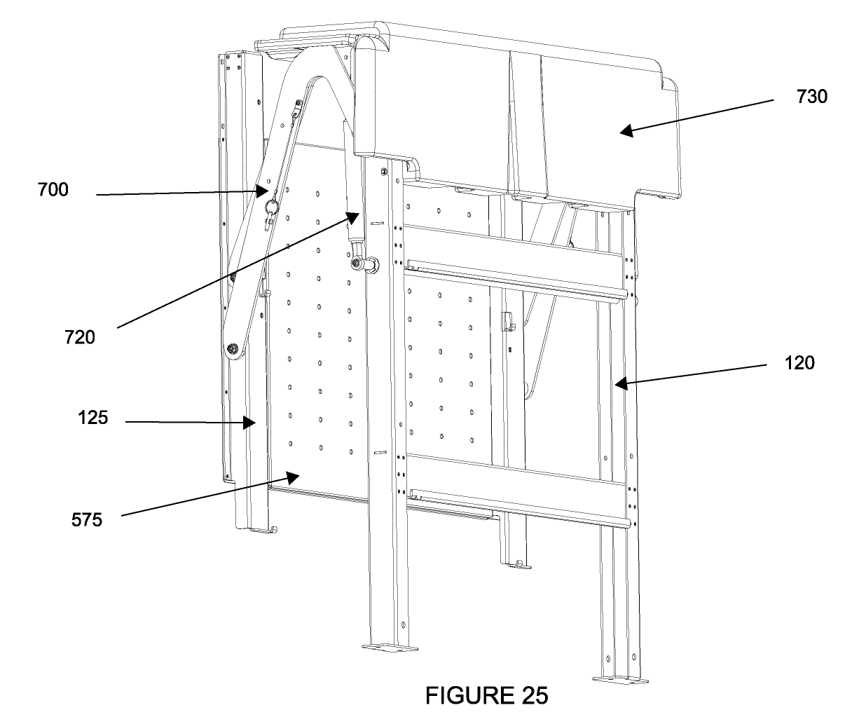

The embodiment of the present invention of FIG. 20 shows the first opening 130 of the container 105 partially lifted to reveal the integrated display monitor 580, which is mounted to the mounting board 575. In some embodiments, hinges 700 may be included to support and lift the mounting board 575 as the handle 610 is pulled. As shown in this FIG. 20, there may be at least two adjacent hinges 700, which in some embodiments form a trapezoidal shape. The structure of the hinge system is described in further detail with reference to FIGS. 25 to 28.

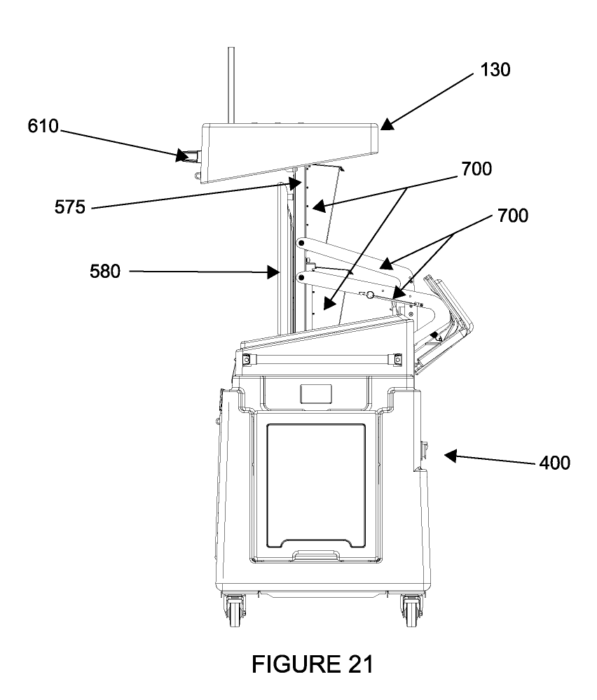

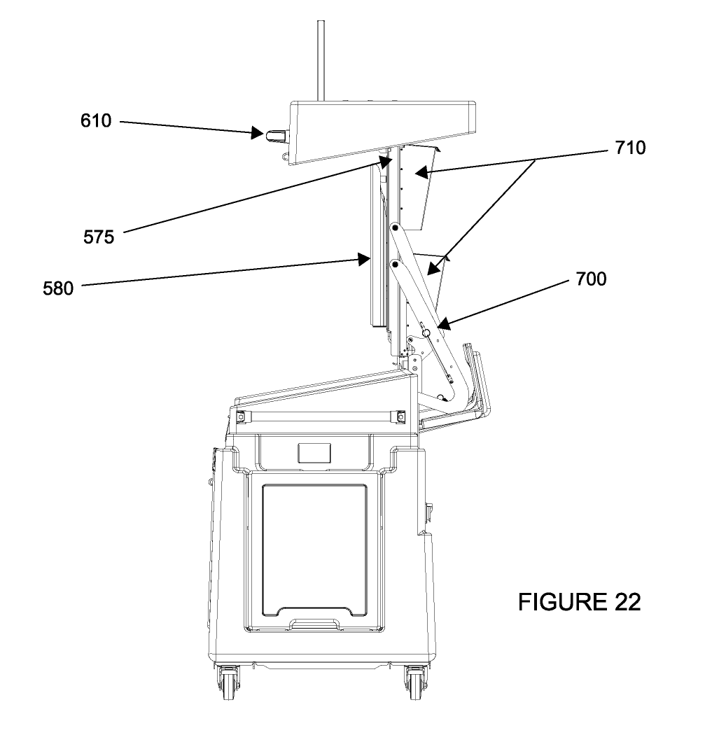

FIG. 21 shows a side view of another embodiment of the present invention including rear compartments 710. In this Figure, the mounting board 575 and display monitor 580 are adjusted to a forward position. FIG. 22 shows a further embodiment of the present invention where the mounting board 575 and display monitor 580 are adjusted to an extended rear position. As shown, the position of the mounting board 575 may be adjusted by a user for maximum flexibility in height and orientation.

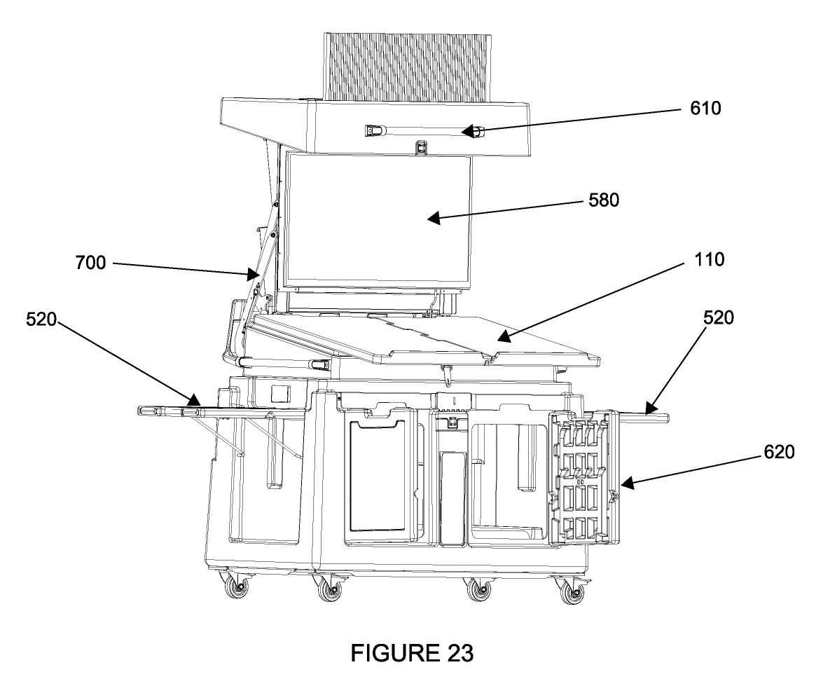

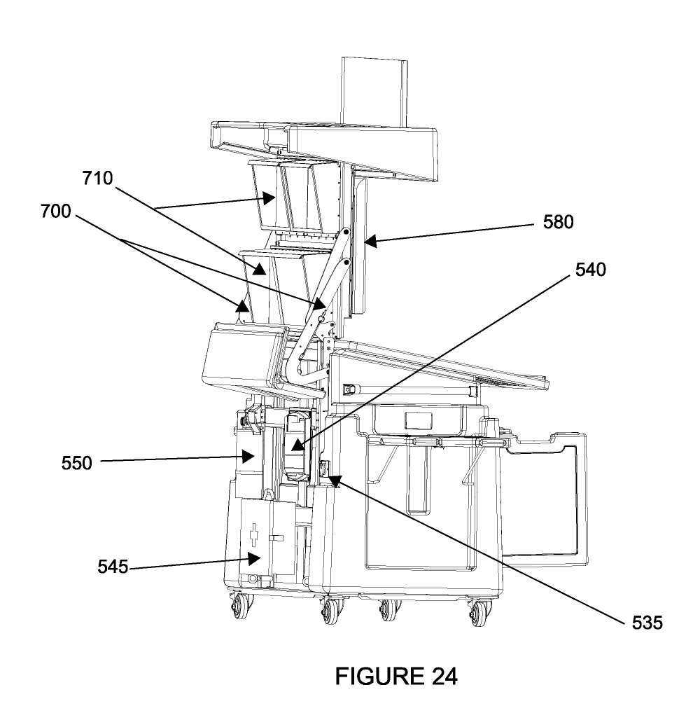

FIG. 23 is an isometric view of the embodiment of the present invention shown in FIG. 22, with the compartment doors 620 and shelves 520 in an open configuration. FIG. 24 shows a rear isometric view of the embodiment shown in FIG. 23 including a safety section with a first aid kit 550, an eyewash station 540 and a fire extinguisher 550. In some embodiments, the safety section may further include a defibrillator (not shown), an oxygen tank and mask (not shown), and materials such as safety policies, risk assessment materials and work permits, along with other safety equipment that may be readily contemplated by the skilled artisan.

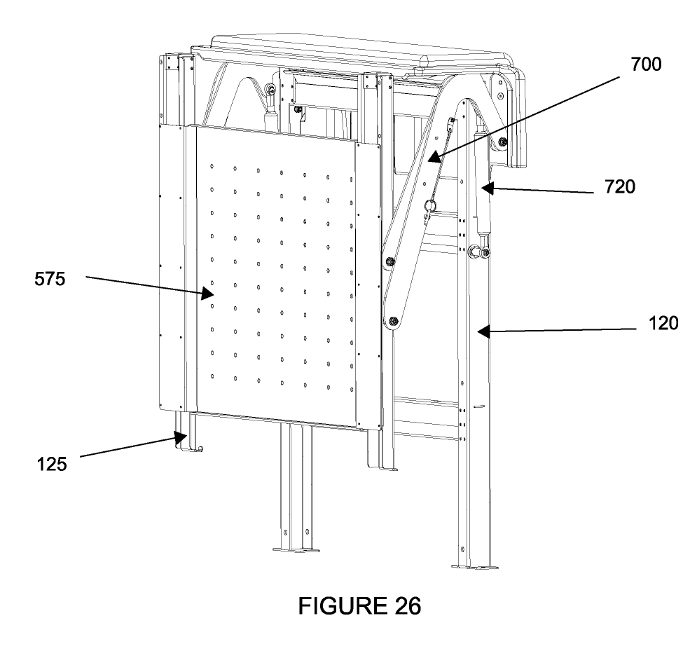

FIG. 25 is a rear isometric view of one embodiment of the present invention showing the structure of the hinge system isolated from the display unit in a collapsed form, including the mounting board 575, the support frame 120 and the hinges 700. The hinges 700 are connected at one end to the mounting frame 125, and at the other end to the support frame 120. Two sets of hinges 700 may be connected to two sides of the mounting frame 125, as shown in FIG. 25. In one embodiment, the hinges 700 may be covered by a cover 730, which may form a part of the container 105. In another embodiment, a hydraulic piston 720 may be further included. The hydraulic piston 720 may be connected to the hinges 700, to facilitate the movement of the hinges for adjusting the position of the mounting board 575 and/or display monitor 580 (not shown in this Figure). FIG. 26 shows the embodiment shown in FIG. 25 in a front isometric view.

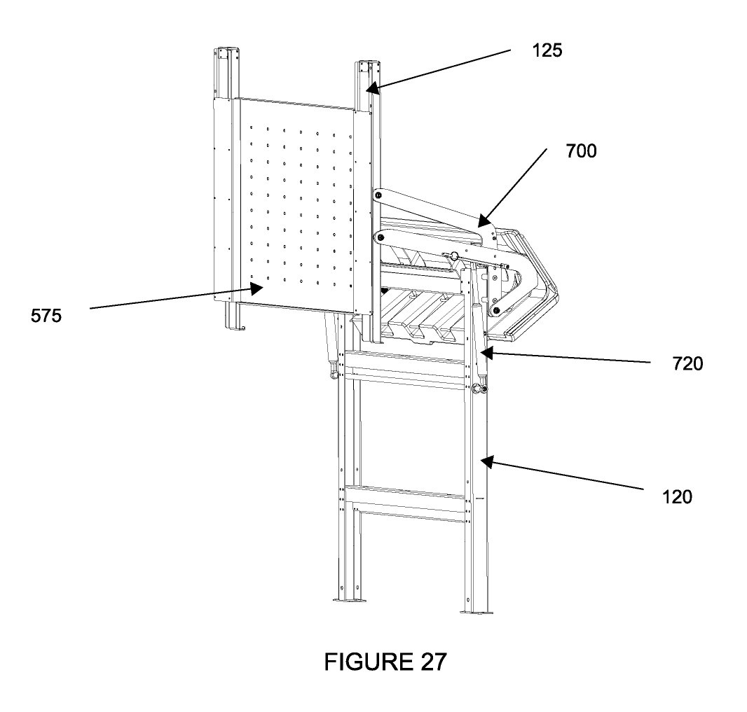

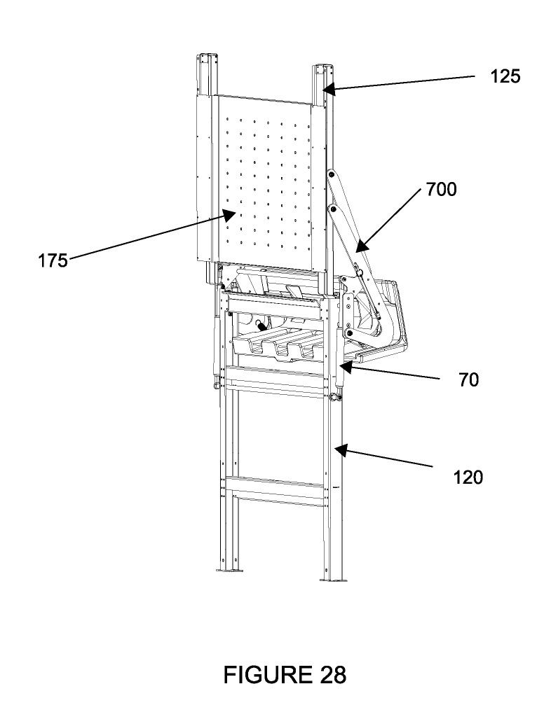

FIG. 27 shows a front isometric view of the isolated system shown in FIGS. 25 and 26 with the mounting board 575 in a forward position. FIG. 28 shows the isolated system of the previous three Figures with the mounting board 575 in an extended rear position.

A person understanding this invention may now conceive of alternative structures and embodiments or variations of the above, all of which are intended to fall within the scope of the invention as defined in the claims that follow.

1. A kit for storing a display unit comprising:
a container having a first opening;
a tabletop for operatively attaching to the container at the first opening for use as a table; and
a support frame for operatively mounting displays means thereon;
wherein the support frame is constructed and arranged to operatively couple to the container such that the support frame can support the display means mounted thereon; and
wherein the tabletop and the support frame are constructed and arranged for storage.

2. The kit of claim 1, wherein a support plate is attached to the bottom of the container.

3. The kit of claim 1, wherein a plurality of wheels is operatively coupled to the container for moving the container.

4. The kit of claim 1, wherein the kit includes at least one tabletop support beam for operatively coupling to the tabletop for structural support.

5. The kit of claim 1, wherein the display means are constructed and arranged for storage in the container, and wherein the display means are selected from the group consisting of: a mounting frame, a protective cover, a display monitor, a display monitor mount, at least one mounting board, a signage banner, at least one file organizer, an eyewash station, a first aid kit, a fire extinguisher, a defibrillator, an electrical outlet or power bar, at least one organizational bracket, and a combination thereof.

6. A display unit comprising:
a container having a first opening;
a tabletop for operatively attaching to the container at the first opening for use as a table; and
a support frame for operatively mounting display means thereon;
wherein the support frame is constructed and arranged to operatively couple to the container such that the support frame can support the display means mounted thereon; and
wherein the tabletop and the support frame are constructed and arranged for storage.

7. The display unit of claim 6, wherein a support plate is attached to the bottom of the container.

8. The display unit of claim 6, wherein a plurality of wheels is operatively coupled to the container for moving the container.

9. The display unit of claim 6, wherein the display unit further includes at least one tabletop support beam for operatively coupling to the tabletop for structural support.

10. The display unit of claim 6, wherein the tabletop has at least two panels that are lockable to each other.

11. The display unit of claim 6, wherein the container includes a side opening and at least one door is attached to the container at the side opening to enable access to the container through the side opening.

12. The display unit of claim 6, wherein at least one shelf is operatively coupled to the container.

13. The display unit of claim 6, wherein the display unit has at least one electrical outlet.

14. The display unit of claim 6, wherein at least one handle is operatively connected to the support frame for lifting the display unit.

15. The display unit of claim 6, wherein the display means includes a mounting frame operatively coupled to the support frame.

16. The display unit of claim 15, wherein at least one mounting board is operatively coupled to the mounting frame.

17. The display unit of claim 6, wherein the display unit is made of rust resistant material.

18. The display unit of claim 6, wherein the display means are constructed and arranged for storage in the container, and wherein the display means are selected from the group consisting of: a mounting frame, a protective cover, a display monitor, a display monitor mount, at least one mounting board, a signage banner, at least one file organizer, an eyewash station, a first aid kit, a fire extinguisher, a defibrillator, and an electrical outlet, at least one organizational bracket, and a combination thereof.

19. The kit as in claim 1, wherein the container is made from a rugged weight bearing material being suitable for outdoor use.

20. The display unit as in claim 6, wherein the container is made from a rugged weight bearing material being suitable for outdoor use.

21-24. (canceled)
